(19) United States
(12) Patent Application Publication
(10) Pub. No.: US 2007/0139221 A1
(43) Pub. Date: Jun. 21, 2007

(54) Emergency vehicle and locomotive warning system

(76) Inventor: Joseph P. Falvey, Poplar Bluff, MO (US)

Correspondence Address: Galasso & Associates, LP, P. O. Box 26503, Austin, TX, 78755-0503, US

(21) Appl. No.: 11/312,791

(22) Filed: Dec. 20, 2005

(51) Int. Cl. G08G 1/00; G01S 13/08

(52) U.S. Cl. 340/902; 342/51

(57) ABSTRACT

An emergency vehicle and locomotive locating and warning device comprising a transponder for transmitting a radio frequency signal and a multi-signal receiver capable of receiving a signal from the transponder. The multi-signal receiver transmits a signal which indicates the type of emergency vehicle or locomotive. The received signal causes a signal light within the receiving vehicle to illuminate based on the type of signal received. Depending on the type of signal received, a light will illuminate within the vehicle that not only indicates the type of emergency vehicle or locomotive but the direction from which the emergency vehicle is approaching.

### FIELD OF THE DISCLOSURE

A transmitter capable of emitting a signal to a multi-signal receiver which indicates the type and direction of an oncoming emergency vehicle or a train

### BACKGROUND

At one time or another anyone who drives has encountered an emergency vehicle and/or a train. Once you hear the sirens going it becomes a task to determine what type of emergency vehicle is approaching and from what direction it is coming. Since the law requires that you go right for sirens and lights, locating an emergency vehicle is important. Additionally, you never want to become involved in an accident with the emergency vehicle or as a result of an emergency vehicle approaching.

As automakers are striving to cut down on the outside noise that can be heard within a vehicle, the amount of time that a driver has to respond to an emergency vehicle is being cut down. The more that a vehicle becomes insulated to outside noises the more a driver becomes insulated to the sirens of an approaching emergency vehicle. By reducing the amount of notice a driver receives from the sirens of an emergency vehicle, the amount of time it takes to locate the vehicle and the direction in which it is traveling is also reduced, thereby increasing the risk of slowing down an emergency vehicle or potentially being involved in an accident with the emergency vehicle.

Locomotives are another danger that many drivers face, particularly if you live near a railroad track. Not all railroad intersections have advanced visibility in order to determine if a train is forthcoming. Therefore, you must come up to the railroad crossing stop and look both ways. Unfortunately, there have been a number of accidents involving trains as a result of this particular system. Some of these have resulted from engineer negligence, some from driver negligence and some from shear circumstances. Depending on the surrounding environment of a particular railroad crossing, a train sounding its whistle may not always be indicative of the direction for which a train is traveling. For example, if you have a lot of buildings surrounding a particular railroad crossing, there are times when the buildings will cause the train whistle to reflect off of the buildings creating a false sense of direction for the signaling train. For those who have a hard time hearing anyway, this can lead them to believe a train is leaving an intersection instead of approaching an intersection which sets up a potentially dangerous scenario.

There are several prior art attempts to address the problems associated with emergency vehicle warning systems and provide drivers with alternatives for detecting emergency vehicles and/or locomotives. One example of such a system is described in U.S. Pat. No. 3,997,868 by Ribnick et al. In Ribnick et al., a radio frequency signal generating means is mounted in an emergency vehicle which is capable of generating a plurality of tones. A radio frequency signal receiver is then mounted in other vehicles making it capable for the signal from the radio frequency signal generating means to be received. A tone signal detection device capable of receiving the radio frequency signal and causing an indicator means to output a unique detectable signal. This signal is also capable of indicating the relative proximity of the emergency vehicle and if desired, directional means may also be provided. Ribnick et al. also claims a source of audible signals.

In U.S. Pat. No. 5,572,201 by Graham et al., a warning system for alerting a person of an emergency situation using a transmitter responsive to a visual or acoustic alerting system for transmitting an alarm signal on an RF carrier and a control signal on a sideband of the carrier is described. According to Graham et al. a visual or acoustic alerting system could be a siren or light system of an emergency vehicle. Graham et al. calls for a tuneable receiver for receiving commercial broadcasts in a normal operating mode transfers to an emergency mode upon detection of the control signal and converts the alarm signal to an acoustic signal.

Another alternative is described in U.S. Pat. No. 6,614,362 by Siegel. In Siegel, a method for an emergency vehicle alert system for transmitting signals from one or more emergency vehicles to a nearby commuter vehicle includes activating an initiation switch in the emergency vehicles. The transmitter then transmits a uniquely individual stamp of a predefined frequency and a GPS signal. This stamp is capable of being detected by other emergency vehicles and commuter vehicles equipped with appropriate receivers.

There are several alternatives available for the detection of emergency vehicles. Most of the warning systems comprise the transmittal of a radio frequency signal and the receiving of such signal, however, the output once the signal is received differs greatly.

### SUMMARY OF THE DISCLOSURE

In one embodiment the emergency vehicle warning device comprises a radio frequency transponder

In yet another embodiment the transponder is capable of emitting a signal.

In still another embodiment the emergency vehicle warning device comprises a multi-signal receiver.

In another embodiment the multi-signal receiver is operable to discriminate between two or more radio frequency transponders.

In yet another embodiment the emergency vehicle warning device comprises a color coded warning device.

In still another embodiment the color coded warning device is displayed through a series of lights.

In yet another embodiment the emergency vehicle warning device comprises a directional indicator.

In another embodiment the directional indicator is displayed indicating the location of the emergency vehicle warning device.

In still another embodiment the color coded warning device lights are displayed on the rear-view mirror.

In yet another embodiment the color coded warning device lights are displayed on the outside mirrors.

In another embodiment the color coded warning device lights flash upon receipt of the radio frequency signal.

In still another embodiment a red flashing light on the upper left side of the mirror would indicate an emergency vehicle approaching from the left.

In yet another embodiment a red flashing light in the center on the left side of the mirror would indicated an emergency vehicle is approaching from the right.

In another embodiment a blue flashing light on the lower left side of the mirror would indicated an emergency vehicle is approaching from the rear.

In still another embodiment a yellow flashing light on the upper right side of the mirror would indicate a train is approaching from the left.

In yet another embodiment a yellow flashing light on the lower right side of the mirror would indicate a train is approaching from the right.

In another embodiment the radio frequency transponder produces a signal capable of indicating either an emergency vehicle or a train.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 illustrates a radio frequency transponder and a radio frequency receiver.

FIG. 2 illustrates the mirror system comprised in a typical passenger vehicle and further depicts a set of warning lights for the entire mirror system.

FIG. 3 illustrates a more detailed view of a rear view mirror displaying the various color coded warning lights and the indicative positions.

FIG. 4 illustrates a more detailed view of an outside mirror located on the right side of a vehicle.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

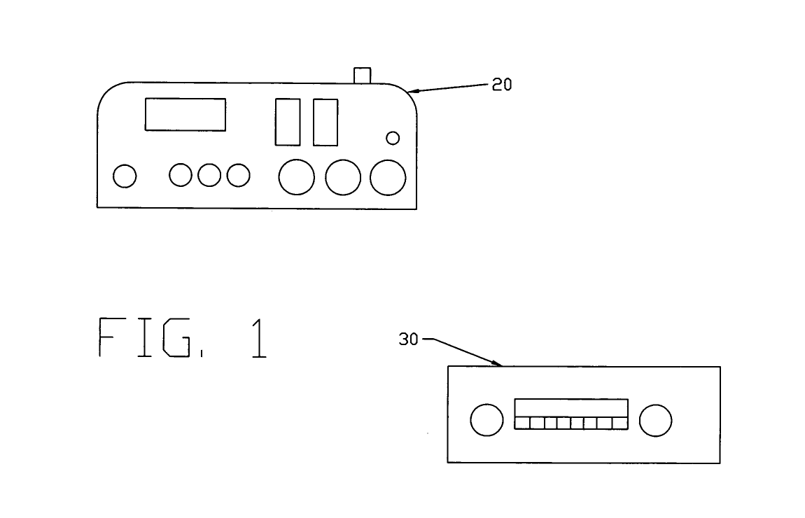

FIG. 1 illustrates the major components of an emergency vehicle warning device 10, which include a radio frequency transponder 20 and a radio frequency receiver 30. The radio frequency transponder 20 would be installed into various emergency vehicles and locomotives on trains. When responding to an emergency, an emergency vehicle would cause the radio frequency transponder 20 to output a signal capable of being received by the radio frequency receiver 30. The radio frequency receiver 30 would be installed into other passenger and commercial vehicles. Train locomotives would also be equipped with the radio frequency transponder 20. When approaching an intersection, the radio frequency transponder 20 would put out a signal which would indicate that a train is approaching the intersection. The radio frequency transponder 20 would be capable of emitting varying signals based on the type of emergency vehicle or whether it is in fact a train approaching. For example, if an ambulance is approaching, then the radio frequency transponder 20 would emit a signal that indicates that the approaching emergency vehicle is an ambulance. Alternatively, if a train is approaching, then the radio frequency transponder 20 would emit a signal unique to a train. Because the radio frequency receiver 30 is a multi-signal receiver, it is capable of distinguishing between the varying signals received.

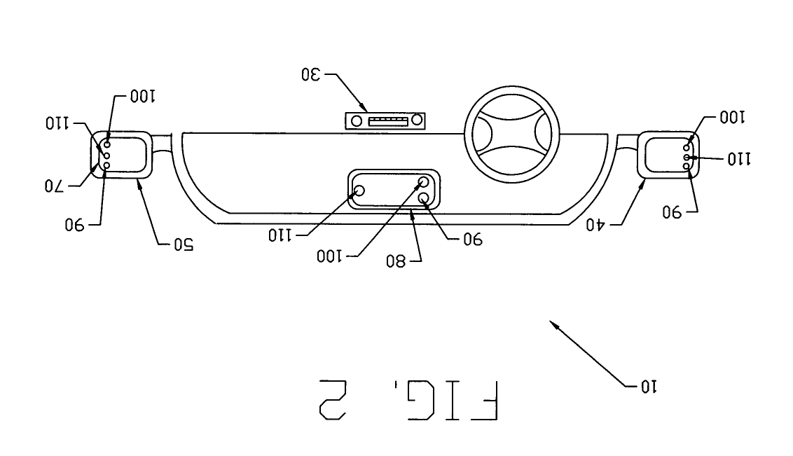

FIG. 2 illustrates the mirror system comprised in a typical passenger vehicle and further depicts a series of warning lights for the entire mirror system. Specifically, FIG. 2 illustrates a left outside mirror 40, a right outside mirror 50 and a rear view mirror 60. Each of these mirrors is equipped with a series of lights capable of illuminating and forming a color coded warning device 70. Each of these mirrors also provide a directional indicator 80 based on the color coded warning device 70. Based on the position of the illuminated light comprised within the color coded warning device 70, the driver of a vehicle can determine the direction of the approaching emergency vehicle or locomotive. For example, if a light illuminates on the lower left side of a mirror, it indicates that an emergency vehicle is approaching from the rear. Based on the illumination of the color coded warning device 70, a driver knows how to respond to the approaching emergency vehicle. Additionally, a driver is capable of determining if a train is approaching a particular intersection when the driver is coming up to the intersection. Because not all train crossings provide good advanced visibility, the emergency vehicle warning device 10 allows a driver to be alerted prior to reaching a railroad crossing and further allows the driver to determine the direction of the oncoming train.

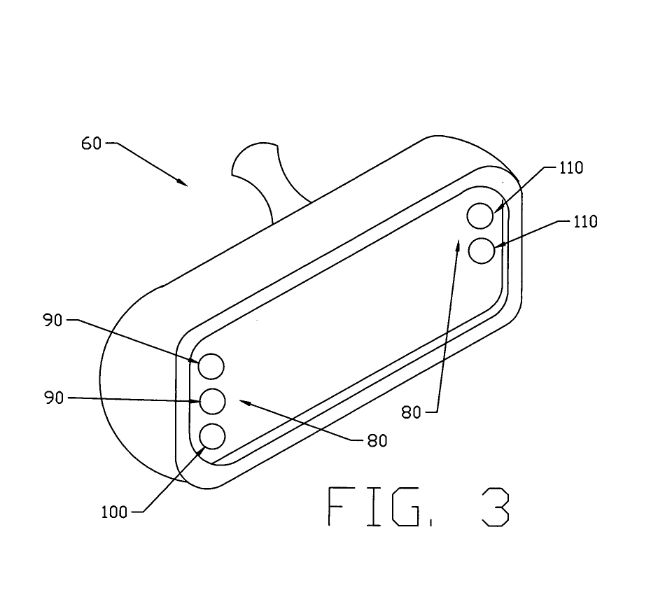

FIG. 3 depicts the color coded warning device 70 as depicted through a series of lights. Each light illuminates in varying colors with each color being specific to a particular instance. Additionally, the location of the illuminated light is a factor in illustrating the direction of an approaching emergency vehicle or train. For example, a red light 90 flashing in the upper left comer of the mirror indicates that an emergency vehicle is approaching from the left. Alternatively, a red light 90 flashing in the center position on the left side of the mirror indicates that an emergency vehicle is approaching from the right. A blue light 100 flashing in the lower left corner of a the mirror indicates that an emergency vehicle is approaching from the rear. A yellow light 110 flashing on the upper right side of the mirror would indicate a locomotive approaching from the left. A yellow light 110 flashing on the lower right side of the mirror would indicate a locomotive is approaching from the right. The lights are designed to flash upon receipt of the appropriate signal so as to attract the driver's attention to the color coded warning device 70.

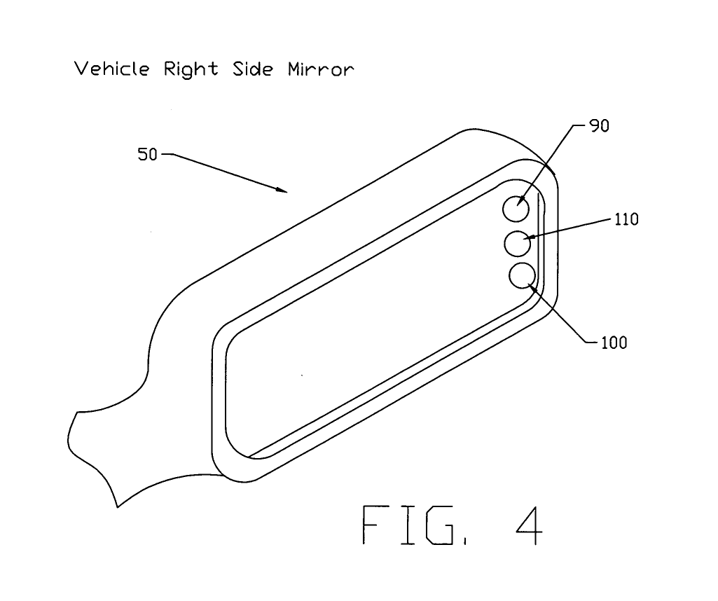

FIG. 4 illustrates a vehicle right side mirror. In this particular configuration each of the side mirrors comprises a set of lights. If a light flashes on the right side of the vehicle, it would indicate that the particular emergency vehicle or train is approaching from the right. Alternatively, if a light flashes on the left side mirror, then it would indicate that the emergency vehicle is approaching from the left. Again a red light 90 would flash indicating an emergency vehicle, a yellow light 110 would indicate a train and a blue light 100 would indicate an emergency vehicle approaching from in front or from behind depending whether it was flashing on the left or right side mirror. For example a blue light 100 flashing on the right side mirror would indicate an emergency vehicle approaching from the rear. Alternatively, if the blue light 100 was flashing on the left side mirror, it would indicate an emergency vehicle is approaching from the front.

By having the additional color coded warning device 70 which includes a series of lights, a driver not only has a audio warning system of emergency vehicle but also has a visual warning system, that provides direction, thereby allowing a driver to more quickly and properly respond to emergency vehicle. The more advanced notice a driver receives the better the driver can respond in trying to clear a path of the oncoming emergency vehicle. Additionally, by having a visual warning system for trains, a driver can more easily detect whether a train is approaching the same intersection as the driver. Therefore, this emergency vehicle warning device 10 will assist in allowing emergency vehicles to more quickly reach an emergency situation and help decrease the dangers that emergency vehicle encounter when responding to an emergency.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. An emergency vehicle warning device comprising:
a radio frequency transponder capable of emitting a signal;
a multi-signal receiver operable to discriminate between two or more radio frequency transponders;
a color coded warning device, wherein said warning device is displayed through a series of lights; and
a directional indicator, wherein said directional indicator is displayed indicating the location of the emergency vehicle warning device.

2. The emergency vehicle warning device of claim 1, wherein said color coded warning device lights are displayed on the rear view mirror.

3. The emergency vehicle warning device of claim 1, wherein said color coded warning device lights are displayed on the outside mirrors.

4. The emergency vehicle warning device of claim 1, wherein said color coded warning device lights flash upon receipt of said radio frequency signal.

5. The emergency vehicle warning device of claim 1, wherein a red flashing light on the upper left side of the mirror would indicate an emergency vehicle approaching from the left.

6. The emergency vehicle warning device of claim 1, wherein a red flashing light in the center on the left side of the mirror would indicate an emergency vehicle approaching from the right.

7. The emergency vehicle warning device of claim 1, wherein a blue flashing light on the lower left side of the mirror would indicate an emergency vehicle approaching from the behind.

8. The emergency vehicle warning device of claim 1, wherein a yellow flashing light on the upper right side of the mirror would indicate a train approaching from the left.

9. The emergency vehicle warning device of claim 1, wherein a yellow flashing light on the lower right side of the mirror would indicate a train approaching from the right.

10. The emergency vehicle warning device of claim 1, wherein said radio frequency transponder produces a signal capable of indicating either an emergency vehicle or a train.

11. An emergency vehicle warning system comprising:
a radio frequency transponder capable of emitting a signal;
a multi-signal receiver operable to discriminate between two or more radio frequency transponders;
a color coded warning device, wherein said warning device is displayed through a series of lights;
a directional indicator, wherein said directional indicator is displayed by the location of the warning device
a set of display lights located on at least one mirror.

12. The emergency warning system of claim 11, wherein a red flashing light on the upper left side of the mirror would indicate an emergency vehicle approaching from the left.

13. The emergency vehicle warning device of claim 11, wherein a red flashing light in the center on the left side of the mirror would indicate an emergency vehicle approaching from the right.

14. The emergency vehicle warning device of claim 11, wherein a blue flashing light on the lower left side of the mirror would indicate an emergency vehicle approaching from the behind.

15. The emergency vehicle warning device of claim 11, wherein a yellow flashing light on the upper right side of the mirror would indicate a train approaching from the left.

16. The emergency vehicle warning device of claim 11, wherein a yellow flashing light on the lower right side of the mirror would indicate a train approaching from the right.

17. The emergency vehicle warning device of claim 11, wherein said radio frequency transponder produces a signal capable of indicating either an emergency vehicle or a train.

18. The emergency vehicle warning device of claim 11 further comprising a set a set of display lights located on a review mirror.

19. The emergency vehicle warning device of claim 11 further comprising a set of display lights located on at least one outer mirror.
